(19) United States
(12) Patent Application Publication
(10) Pub. No.: US 2016/0147390 A1
(43) Pub. Date: May 26, 2016

(54) IMAGE DISPLAY APPARATUS, IMAGE DISPLAY METHOD, AND NON-TRANSITORY COMPUTER READABLE RECORDING MEDIUM

(71) Applicant: Samsung Electronics Co., Ltd., Gyeonggi-do (KR)

(72) Inventors: Im-kyeong YOU, Seoul (KR); Seung-hwan CHOI, Gyeonggi-do (KR)

(73) Assignee: Samsung Electronics Co., Ltd.

(21) Appl. No.: 14/952,552

(22) Filed: Nov. 25, 2015

(30) Foreign Application Priority Data
Nov. 26, 2014 (KR) 10-2014-0166742

(51) Int. Cl. G06F 3/0482; H04M 1/725; G06F 3/0481; H04L 29/08; G06F 3/0484; G06F 3/0486

(52) U.S. Cl. CPC G06F 3/0482; G06F 3/04842; G06F 3/0486; G06F 3/04817; H04L 67/12; H04M 1/72533

(57) ABSTRACT

An image display apparatus, an image display method, and a non-transitory computer readable recording medium are provided. The image display method includes displaying a control screen for at least one user apparatus on the image display apparatus; selecting a control item displayed on the control screen as a control command of the at least one user apparatus; and displaying an integrated control screen for controlling a plurality of functions for the at least one user apparatus in a group based on the selected control item.

### PRIORITY

This application claims priority under 35 U.S.C. 119(a) to Korean Patent Application Serial No. 10-2014-0166742, which was filed in the Korean Intellectual Property Office on Nov. 26, 2014, the entire content of which is incorporated herein by reference.

### BACKGROUND

1. Field of the Invention

The present disclosure generally relates to an image display apparatus, an image display method, and a non-transitory computer readable recording medium. More particularly, the present disclosure relates to an image display method for allowing a user of an image display apparatus such as a smart phone to set and use a control operation through a control screen of a user apparatus such as a TV and a non-transitory computer readable recording medium.

2. Description of the Related Art

Social media services are recently gaining popularity and diversity in services. An important service is to automatically send an e-mail such as “glad to meet you” if a new address is registered in a contact directory. As the service, there is an IFTTT (IF This, Then That) service to allow people to take actions without missing many repetitive or important incidents.

The service is known for promoting on-line productivity at an early stage. The reason why the service receives attention is for preparing for a so-called ‘Internet of Things (IoT)’ age. Defining one task is referred to as a recipe. Service objects that may be combined are referred to as a channel. As the current channel, there are 68 such as Facebook, Twitter, Evernote, G-mail, Dropbox, Instagram, and Tumbler. That is, any task defined by variously combining 68 channels may be automatically performed.

When smart devices use these channels, they may for example, turn on a heater when temperature falls or may receive an alarm when people move in an unoccupied house. To connect new devices to the IFTTT service, the IFFTT service publishes an application program interface (API) which allow the devices to be used in the channel.

The existing methods of providing integrated services using smart devices linked with third party businesses, for example, turning on a heater when temperature falls, still have many limitations. For example, the IFFTT service provides a text list format for an operation (or function) of applications provided by the third party businesses. Therefore, a user has a hard time reading the text one by one to understand available functions. Further, there is a limitation in that applications or IoT devices of the third party businesses which are not joined in services may not be used in services.

### SUMMARY

The present disclosure has been made to address at least the above disadvantages and other disadvantages not described above, and to provide at least the advantages described below.

According to an aspect of the present disclosure, an image display method for allowing a user of an image display apparatus such as a smart phone to simply set and use a control operation through a control screen of a user apparatus such as a TV and a computer readable recording medium are provided.

According to an aspect of the present disclosure, an image display method of an image display apparatus includes displaying a control screen for at least one user apparatus on the image display apparatus; selecting the control item displayed on the control screen as a control command of the at least one user apparatus; and displaying an integrated control screen for controlling a plurality of functions for the at least one user apparatus in a group based on the selected control item.

The displaying of the control screen includes displaying a visual symbol used to select a control item on the control screen and the control item may be selected using at least one of the visual symbol and a button formed on the main body of the image display apparatus.

The visual symbol may include one of an icon movable by a user's drag operation, a display button, and a highlight display and when the visual symbol is positioned in a selectable area of the control item by the user's movement of the visual symbol, a display state of the visual symbol may be changed.

The image display method may further include positioning the visual symbol, which is displayed on the control screen, on the control item, wherein in the displaying of the integrated control screen, when the visual symbol positioned is selected, the integrated control screen may be generated based on the selected control item.

The image display method may further include dragging the visual symbol on the control screen to designate an area including a plurality of control items, in which displaying of the integrated control screen, the integrated control screen may be generated based on the plurality of control items included in the area.

In the displaying of the integrated control screen, the integrated control screen may be generated based on all the control items on the control screen selected by a button formed on the main body of the display screen.

The displaying of the integrated control screen may include displaying control items to be controlled in a group by turning on and off at least one user apparatus.

The control screen for each of the plurality of user apparatus may be displayed on a screen by executing different applications.

In the displaying of the control screen, a generation information confirmation item for confirming the selected control item may be displayed on the control screen.

According to another embodiment of the present disclosure, an image display apparatus includes a display that displays a control screen for at least one user apparatus on the image display apparatus; and if a control item displayed on the control screen is selected as a control command of the at least one user apparatus, a controller that controls an integrated control screen for controlling a plurality of functions for the at least one user apparatus in a group based on the selected control item to be displayed on the display.

The display may further display a visual symbol used to select the control item on the control screen and the control item may be selected using at least one of the visual symbol and a button formed on a main body of the image display apparatus.

The visual symbol may include one of an icon movable by a user's drag operation, a display button, and a highlight display and when the visual symbol is positioned in a selectable area of the control item by the user's movement of the visual symbol, a display state of the visual symbol may be changed.

The controller may control the display to position the visual symbol, which is displayed on the control screen, on the control item and if the positioned visual symbol is selected, generate the integrated control screen based on the selected control item.

The display may further display an area including a plurality of control items selected by dragging the visual symbol on the control screen and the controller may generate the integrated control screen based on the plurality of control items included in the area.

The controller may generate the integrated control screen based on all the control items on the control screen selected by the button formed on the main body.

The display may further display control items to be controlled in a group by turning on and off the at least one user apparatus.

The control screen for each of the plurality of user apparatus may be displayed on a screen by executing different applications.

The control screen may include a generation information confirmation item for confirming the selected control item and if the generation information confirmation item is selected, the display may display the selected control item.

According to another aspect of the present disclosure, a non-transitory computer readable recording medium having recorded thereon a program for executing an image display method of an image display apparatus, wherein the image display method may include: displaying a control screen for at least one user apparatus on the image display apparatus; selecting the control item on the control screen as a control command of the at least one user apparatus; and displaying an integrated control screen for controlling a plurality of functions for the at least one user apparatus in a group based on the selected control item.

The displaying of the control screen may include displaying a visual symbol used to select a control item on the control screen and the visual symbol may include one of an icon movable by a user's drag operation, a display button, and a highlight display and when the visual symbol is positioned in a selectable area of the control item by the movement, a display state of the visual symbol may be changed.

### BRIEF DESCRIPTION OF THE DRAWINGS

The above and other aspects, features and advantages of the present disclosure will be more apparent from the following detailed description, taken in conjunction with the accompanying drawings, in which:

FIG. 1A is a diagram illustrating a device integrated control service system according to an embodiment of the present disclosure;

FIG. 1B is a diagram illustrating a device integrated control service system according to another embodiment of the present disclosure;

FIG. 2 is a block diagram illustrating a detailed structure of an image display apparatus illustrated in FIGS. 1A and 1B;

FIG. 3 is a block diagram illustrating another detailed structure of the image display apparatus illustrated in FIGS. 1A and 1B;

FIGS. 4A to 4E are diagrams illustrating a mode generation process according to an embodiment of the present disclosure;

FIG. 5 is a diagram illustrating a screen which appears when a generation information confirmation item is selected from the screen of FIG. 4C;

FIGS. 6A to 6C are diagrams illustrating a list of a pre-generated mode;

FIGS. 7 and 8 are diagrams for describing a process of selecting a control item from a control screen;

FIG. 9 is a diagram for describing a process of generating a control item on the control screen as control information;

FIG. 10 is a diagram for describing maintenance of a setting value when a layout of the control screen is changed;

FIG. 11 is a flowchart illustrating a process of driving an image display apparatus according to an embodiment of the present disclosure; and

FIG. 12 is a flowchart illustrating an image display method according to an embodiment of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” as used herein indicate the presence of disclosed corresponding functions, operations, elements, and the like, and do not limit additional one or more functions, operations, elements, and the like. In addition, it should be understood that the terms “include” or “have” as used herein are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” as used herein include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” as used herein may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be referred to as a second element without departing from the scope of the present disclosure, and similarly, a second element may be referred to as a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” as used herein may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in describing the various embodiments of the present disclosure.

An electronic device or device according to various embodiments of the present disclosure, for example, may include at least one of a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mounted-device (HMD), an electronic glasses, an electronic clothing, an electronic bracelet, an electronic necklace, an electronic appcessory, an electronic tattoo, a smart mirror, or a smart watch).

In other embodiments, an electronic device or device may be a smart home appliance, for example, a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console (e.g., Xbox® PlayStation®); an electronic dictionary; an electronic key; a camcorder; or an electronic frame.

In other embodiments, an electronic device or device may include at least one of a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller machine (ATM) of a financial institution, a point of sale (POS) device at a retail store, or an Internet of Things device (e.g., a lightbulb, various sensors, an electronic meter, a gas meter, a sprinkler, a fire alarm, a thermostat, a streetlamp, a toaster, a sporting equipment, a hot-water tank, a heater, or a boiler and the like).

In certain embodiments, an electronic device or device may include at least one of a piece of furniture or a building/structure; an electronic board; an electronic signature receiving device; a projector; and various measuring instruments (e.g., a water meter, an electricity meter, a gas meter, or a wave meter).

An electronic device or device according to various embodiments of the present disclosure may also include a combination of one or more of the above-mentioned devices.

Further, it will be apparent to those skilled in the art that an electronic device or device according to various embodiments of the present disclosure is not limited to the above-mentioned devices.

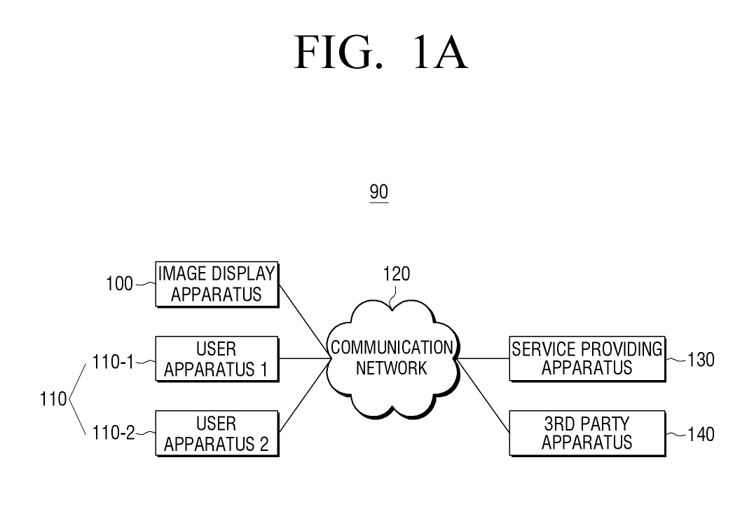

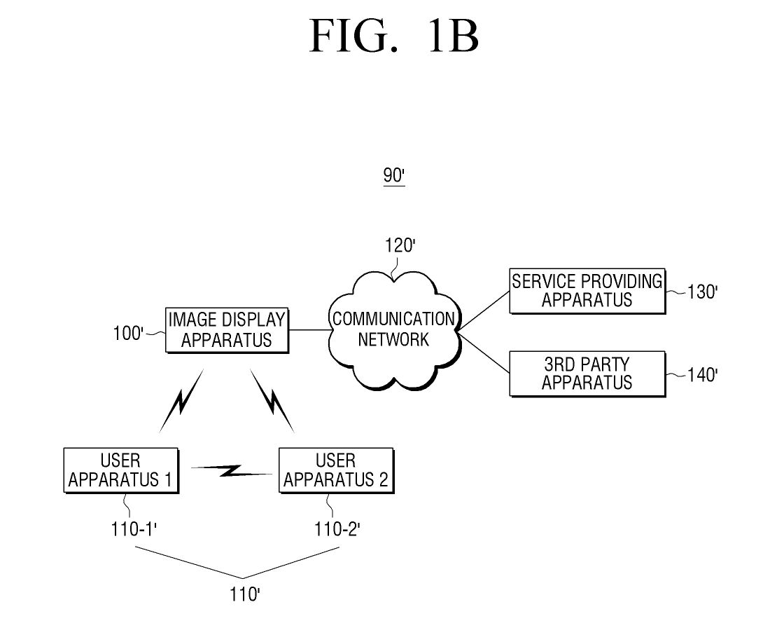

FIG. 1A is a diagram illustrating a device integrated control service system according to an embodiment of the present disclosure.

As illustrated in FIG. 1A, a device integrated control service system 90 according to an embodiment of the present disclosure includes some or all of an image display apparatus 100, a user apparatus 110, a communication network 120, a service providing apparatus 130, and a third party apparatus 140.

Herein, including some or all means that some components such as the third party apparatus 140 may be omitted or components such as the image display apparatus 100 may be integrated in other components such as the user apparatus 110 but in order to help in the understanding of the present disclosure, the description of the device integrated control service system 90 includes all the components.

The image display apparatus 100 may use services for integrally controlling at least one of the user apparatus 110, for example, a smart phone, an air conditioner or a TV, a heater, a lighting apparatus, a locking apparatus, etc., which are owned by a user of the image display apparatus 100. The image display apparatus 100 may include a smart phone, a laptop computer, a desktop computer, a tablet PC, and a wearable apparatus and may further include a PMP, an MP3, etc., which may display an image. The image display apparatus 100 such as a TV may be linked with a broadcast receiver such as a set top box (STB).

A device integrated control according to an embodiment of the present disclosure may include a control for performing a plurality of functions including operations for one user apparatus 110 in a group and further include an integrated control for the plurality of user apparatus 110. For example, the TV may simultaneously perform an operation of selecting a specific channel and automatically controlling a volume to perform a plurality of operations in a group. Further, to integrally control the lighting apparatus and the TV, when a user arrives home the user may turn on a lighting apparatus and the TV simultaneously.

The user of the image display apparatus 100 may use their image display apparatus 100 so that an apparatus of the user may be designated to be included in a category of the integrated control service. In other words, the image display apparatus 100 may set an operation for the integrated control service for the user apparatus 110 of the user and set the operation for services for the image display apparatus 100 setting services. For example, since the mobile apparatus such as the smart phone, the wearable apparatus, and the tablet PC may display an image, a screen for the integrated control service may be provided to the user to provide an operation for a service and the user may set the user apparatus so that a WiFi module in the user apparatus is automatically turned on when the user arrive home. As described above, in the case of the specific image display apparatus 100, the user may set the operation for the user apparatus as the user desires. This becomes a self designation.

The image display apparatus 100 may store a program (or application) for allowing the user apparatus 110 of the user to use the device integrated control service stored in an internal memory and may execute the program upon the user's request. The program may be executed by allowing the user desiring to use services to select icons displayed on the screen. Depending on the execution of the program, the image display apparatus 100 may be linked with the service providing apparatus 130 to receive the services. If the user of the image display apparatus 100 requests the integrated service for operating the image display apparatus 100, the user may additionally operate specific applications based on related information. Applications for additional operations represent applications related to a trigger condition set by the user and an operation corresponding to an action. For example, when the operation “when I arrive home, turn on a lighting apparatus” is set, the occurrence of an event that the user arrives home and the lighting apparatus is turned on may be generated by different applications.

It is assumed that when the image display apparatus 100 is a mobile apparatus such as a smart phone, the user designates the mobile apparatus as an operation performing apparatus and sets an operation corresponding to the trigger condition “when I arrive home”. In this case the mobile apparatus uses, for example, a GPS or position sensor to sense whether the user arrives home. For this purpose, the mobile apparatus may use applications stored therein. When the operation is sensed, the image display apparatus 100 may execute applications to provide sensing event occurrence to the service providing apparatus 130. The image display apparatus 100 may directly provide the sensing event occurrence to the surrounding user apparatus 110, but the related contents thereof will be described below.

The user of the image display apparatus 100 may use the device integrated control services through the image display apparatus 100. Hereinafter, to use services, the user apparatus 110 of the user may be designated. Further, the image display apparatus 100 may be self-designated. Further, the user may generate a mode for controlling the designated user apparatus 110. The mode may be a state or a scheme in which a specific task may be performed. For example, mode 1 and mode 2 may have different operation schemes. The difference between the operation schemes means that the control information is different. For example, when user apparatus 1 110-1 is the air conditioner and user apparatus 2 110-2 is the lighting apparatus, the user may designate the apparatus and generate a mode for controlling the apparatus. For the generation of the mode, the image display apparatus 100 may display the control screen for controlling the user apparatus 1 110-1 based on a user command selected on the screen of the image display apparatus 100 and may display a new control screen for controlling the user apparatus 2 110-2 based on another user selected command on the screen. Each of the control screens may be provided through applications produced by third party providers. The control screen may be provided as initially produced by the third party providers. The control screen may include the same control item but may be provided in other formats without any limit.

In the state in which the control screen for controlling the user apparatus 110 is displayed on the screen of the image display apparatus 100, the user may use icons additionally displayed on the screen of the image display apparatus 100, visual symbols (or visual signs) such as a display button and a highlight display, and a button (or physical input button) formed on a main body of the image display apparatus 100 to set the control information associated with each operation related item on the control screen as a user defined mode. The physical button is for differentiating from the display button displayed on the screen. For example, the user drags the visual symbol for selecting a specific control item on the control screen and moves the visual symbol to a selectable area of the corresponding item. Next, the moving visual symbol may be selected to set the control information related to the corresponding item in the mode. Further, after an area is set by dragging the visual symbols for the plurality of items in the state in which the visual symbols are selected, the control information on the plurality of items may be set by the mode in a group by taking a user's hand off the visual symbols. In addition, to set all the items displayed on the control screen in the mode as the control information, the user may also use the physical button.

Describing this in more detail, the image display apparatus 100 stores image data for a control screen displayed on the present screen. When the user places the visual symbol in the specific control item or drags and sets the area including the plurality of items, the image display apparatus 100 may sense the area using a touch panel to determine what item the user selects. The touch panel may be a resistive-type touch panel or a capacitive type touch panel. In other words, a coordinate value of the sensed area may be matched with the image data to know what item the user selects. By the method, the control information matched to each item is set in the mode. In other words, if the coordinate value of an area sensed on the control screen is a control item corresponding to “cool” of the control screen controlling the air conditioner, the image display apparatus 100 may set an object or a state of the object in the mode as the control information (or control command).

The image display apparatus 100 may change the state of the visual symbol displayed on the screen. In other words, if the selectable area for the control items displayed on the control screen is designated, when the visual symbol is positioned in the designated area, the state of the visual symbol is changed, such that the user may be informed of the fact that the corresponding item may be selected. For example, if the visual symbol is positioned at a boundary area between the items, the state of the visual symbol is not changed, but if the visual symbol is biased to the area of the selectable specific item or is included in the corresponding area, the image display apparatus 100 changes the display state. As in the case described above, the image display apparatus 100 may obtain the coordinate value of a place where the visual symbol is positioned on the control screen and discriminate whether the obtained coordinate value may be changed by a method of comparing whether the obtained coordinate value corresponds to the selectable area of any item with the information stored therein. For this purpose, the image display apparatus 100 may pre-store information about whether each item corresponds to which control item and the coordinate value for the selectable area for the control item and use the pre-stored information related to the control item and the coordinate value for discriminating.

If the designation of the apparatus is completed or the mode setting is completed by using the designated apparatus, the image display apparatus 100 may provide the device integrated control service related information set in the image display apparatus 100 to the service providing apparatus 130 for storage. Further, the stored related information may be retrieved anytime according to the user request to be displayed on the screen. By this method, the user of the image display apparatus 100 may perform editing and deleting operations, etc., on their set information anytime. For example, the generated mode may be set on state, only if necessary.

The user apparatus 110 includes various apparatus of the user of the image display apparatus 100. As described above, it is assumed that the user apparatus 1 110-1 and the user apparatus 2 110-2 are the lighting apparatus and the TV, but the user apparatus 1 110-1 may also be a smart phone and the user apparatus 2 110-2 may also be a locking apparatus of a car. Therefore, when any rule “if the user apparatus 1 110-1 approaches the user apparatus 2 110-2, the user of the image display apparatus 100 unlocks the door of the user apparatus 2 110-2 and if the user apparatus 1 110-1 leaves a defined coverage area, the image display apparatus 100 locks the door” is designated, the user apparatus 2 110-2 may perform the locking and unlocking operation of the door depending on whether the user apparatus 1 110-1 approaches the location of the user apparatus 2 110-2.

For example, the user apparatus 1 110-1 and the user apparatus 2 110-2 may include a communication module which may perform communications. By performing communications using the communication module, the user apparatus 2 110-2 recognizes whether the user apparatus 1 110-2 approaches the user apparatus 2 110-2 and by authenticating the user information of the user apparatus 1 110-1 provided through the communication module, the user apparatus 2 110-2 may unlock the door. The door locking may be performed by a similar method. In other words, when there is no more signal received from the user apparatus 1 110-1, the user apparatus 2 110-2 may lock the door.

The communication network 120 includes all of the wired and wireless communication networks. The wired network includes the Internet networks such as a cable network and a public switched telephone network (PSTN) and a wireless communication network includes a CDMA, a WCDMA, a GSM, an Evolved Packet Core (EPC), Long Term Evolution (LTE or LTE-A), a Wibro network, etc. The communication network 120 according to an embodiment of the present disclosure is not limited thereto and may be a cloud computing network of a next-generation mobile communication system to be implemented in the future. For example, when the communication network 120 is a wired communication network, an access point within the communication network 120 may be connected to a switching center of a telephone station, but when the communication network 120 is a wireless communication network, it may be connected to an SGSN or a gateway GPRS support node (GGSN) which is operated by carriers to process data or connected to various radio access network stations such as Base Transceiver Station (BTS), NodeB, and e-NodeB to process data.

The communication network 120 may include an access point. The access point includes small base stations such as a femto base station or a pico base station which is mainly installed indoors. The femto or pico base station may be classified depending on how many image display apparatus 100 may be connected. The access point includes communication modules such as Zigbee and Wi-Fi which perform wireless communications with the image display apparatus 100. The access point may use a TCP/IP or a real-time streaming protocol for wireless communications. Near field communications may use various standards of radio frequencies (RFs) such as Bluetooth, Zigbee, infrared data association (IrDA), ultra high frequency (UHF), very high frequency (VHF), an ultra wideband (UWB), etc., in addition to Wi-Fi. The access point may extract a position of a data packet, determine the best communication path for the extracted position, and transfer a data packet to the next apparatus, for example, the image display apparatus 100 along the designated communication path. The access point may include multiple networking functions, for example, a router, a repeater, a relay station, etc.

The service providing apparatus 130 may provide device integrated control services for the user apparatus 110 designated by the user. To use the services, the user may pre-store a program for the integrated control services. Further, the service providing apparatus 130 may store and manage the control information on the mode set on the control screen by the user of the image display apparatus 100. For example, when the user sets and stores the mode and then requests editing, deletion, etc., the service providing apparatus 130 may provide the control information of the previously stored mode to perform the operation thereof. Further, the user apparatus 110 may also be controlled depending on the control information of the mode set by the user of the image display apparatus 100. For example, the user apparatus 2 110-2 may be controlled depending on event generation information provided from the user apparatus 1 110-1. For example, when the user apparatus 1 110-1 is a lighting apparatus and the user apparatus 2 110-2 is a TV, the user apparatus 1 110-1 may provide the event generation information that the lighting apparatus is turned on or turned off depending on the user's setting on the service providing apparatus 130. Therefore, the service providing apparatus 130 may transmit a signal to turn on the TV, in this case the user apparatus 2 110-2. The user apparatus 2 110-2 turns on a TV depending on the control content of the transmitted signal.

Further, the service providing apparatus 130 may provide an open application program interface (API) to the third party apparatus 140. In other words, the service providing apparatus 130 may be operated as a platform of the third party apparatus 140. Therefore, the service providing apparatus 130 may store applications in various forms which are provided from the third party apparatus 140. The applications may be associated with the control screen for controlling the operations of the user apparatus 1 110-1 and the user apparatus 2 110-2.

The third party apparatus 140 is an apparatus which is operated by 3rd party developers. In other words, the third party apparatus 140 may provide applications associated with the control screen for setting the operations of the user apparatus 1 110-1 and the user apparatus 2 110-2. That is, the third party developers may develop applications for apparatus so that the Internet of Things (IoT) apparatus may be linked with the present services and provide the developed applications to the market of the service providing apparatus 130.

FIG. 1B is a diagram illustrating a device integrated control service system according to an embodiment of the present disclosure.

Compared to FIG. 1A, in a device integrated control service system 90′ of FIG. 1B, a service providing apparatus 130′ may not manage a device integrated control service like the service providing apparatus 130 of FIG. 1A but perform only functions to serve the market. In other words, an image display apparatus 100′ may not store and manage information on rules set by the user in the service providing apparatus 130′ but may have the information stored within the image display apparatus 100′. Further, the stored rule information may be directly transmitted to the user apparatus 110.

For example, it is assumed that the user defines the rules “when I arrive home, turn on the lighting apparatus and the TV’. In this case, if the image display apparatus 100′ is a mobile apparatus such as a smart phone, the image display apparatus 100′ may have the information on the rules set by the user stored therein. Further, if it is sensed by the mobile apparatus that the user arrives home, the rule information may be directly transmitted along with the event information to the surrounding lighting apparatus. Therefore, the lighting apparatus may determine its own operation based on the received rule and event information and then turn on the lights. The information transmission to the lighting apparatus may be realized by using the above-mentioned direct communication module but is not limited to such communication.

As another example, it is assumed that the user apparatus 1 110-1 is a door lock apparatus and the user apparatus 2 110-2 is the lighting apparatus. In this case, when the user defines the rules “when I arrive home, turn on the lighting and TV” by using the image display apparatus 100′, the set rule related information may be transmitted to and stored in the door lock apparatus. Here, the rule information may be directly transmitted from the image display apparatus 100′ but also may be provided through a communication network 120′ or may be transmitted to and stored in the door lock apparatus by using the service providing apparatus 130′. The service providing apparatus 130′ knows the position address based on the information on the user apparatus 110 designated in the rule information.

Therefore, the door lock apparatus may sense a person's approach through the sensor therein and when a person is sensed approaching, may transmit the rule information to the lighting apparatus to turn on the lighting and at the same time, transmit the rule information to a TV to turn on the TV. The device integrated control service system 90′ may provide services according to various methods in which the setting of the rules, the storing of the rules and the execution of the rules all may occur within the various apparatus of the device integrated control service system 90′.

To use the device integrated control service, the image display apparatus 100′ according to an embodiment of the present disclosure displays the control screen for setting the operation of the user apparatus 110′ on the screen of the image display apparatus 100′ and sets a simple mode using the visual symbol displayed on the screen together with the control screen and the physical button provided in the image display apparatus 100′. In this case, the control screen may be provided to the display in different formats depending on the type of user apparatus 110′. Different formats may mean different layouts of the control screen on the display.

Except for the contents, the image display apparatus 100′, the user apparatus 110′, the communication network 120′, the service providing apparatus 130′ and the third party apparatus 140′ of FIG. 1B have little difference from the image display apparatus 100, the user apparatus 110, the communication network 120, the service providing apparatus 130, and the third party apparatus 140 and therefore the contents thereof will be replaced by the above description.

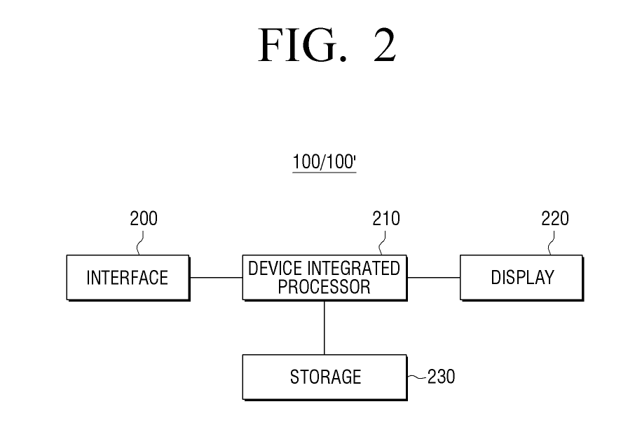

FIG. 2 is a block diagram illustrating a detailed structure of an image display apparatus illustrated in FIGS. 1A and 1B.

Referring to FIG. 2, the image display apparatus 100/100′ according to an embodiment of the present disclosure includes an interface 200, a device integrated processor 210, a display 220, and a storage 230. Some components may be integrated with other components such as the interface 200 or the storage 230 may be integrated in the device integrated processor 230.

The interface 200 includes a communication interface and a user interface. The communication interface may communicate with the service providing apparatus 130 via the communication network 120. Alternatively, the communication interface may perform direct communication with the user apparatus 110. For example, the communication interface may receive applications associated with the control screen for setting the operation of the user apparatus 110 from the service providing apparatus 130 and transfer the received applications to the device integrated processor 210. The user interface includes a power supply button, etc., for turning on and off power to the image display apparatus 100. The power button may also have an additional function to control a specific control item of the control screen.

The device integrated processor 210 controls the overall operation of the interface 200, the display 220, the storage 230, etc., within the image display apparatus 100. For example, the control screen related applications received through the interface 200 may be stored in the storage 230 and then may be retrieved and executed. Further, the device integrated processor 210 may store the control information for the mode set through the control screen displayed on the display 220 in the storage 230. For example, since the device integrated processor 210 stores the image data for the control screen in the storage 230 and matches the coordinate values of the control item selected by the user through the control screen with the image data to determine the specific control item and set the control information on each item as the mode depending on the selection.

The device integrated processor 210 may have several forms. For example, the device integrated processor may be configured only in a hardware or software form or may be configured by an appropriate combination thereof. When the device integrated processor is configured of only hardware, the device integrated processor may include a CPU and a memory and store the applications associated with the control screen in the memory and execute the applications under the control of the CPU. A specific software module of the application programs stored in the memory may also be implemented in hardware without any limit. When the device integrated processor is configured only in software form, the device integrated processor may have a program (or algorithm) associated with the control screen stored therein using a mask ROM, an EPROM, and an EEPROM and execute the program. The device integrated processor may be configured as an appropriate combination of hardware and software without any limit.

The display 220 processes the image data processed under the control of the device integrated processor 210. According to an embodiment of the present disclosure, the image data for the device integrated control service may be preferentially displayed. The control screen is displayed depending on the user command and a visual symbol such as a bubble icon may be further displayed to set the specific control item on the control screen to the mode. Various screens may be implemented but the details regarding content will be described below.

The storage 230 may include at least one of a volatile memory and a nonvolatile memory. When the storage 230 is volatile memory, the overall data processed by the device integrated processor 210 may be temporarily stored. When the storage 230 is nonvolatile memory, the storage 230 may have the applications associated with the control screen stored therein and then provide the applications upon the request of the device integrated processor 210. The storage 230 may provide applications to allow the device integrated processor 210 to store the applications in its internal memory.

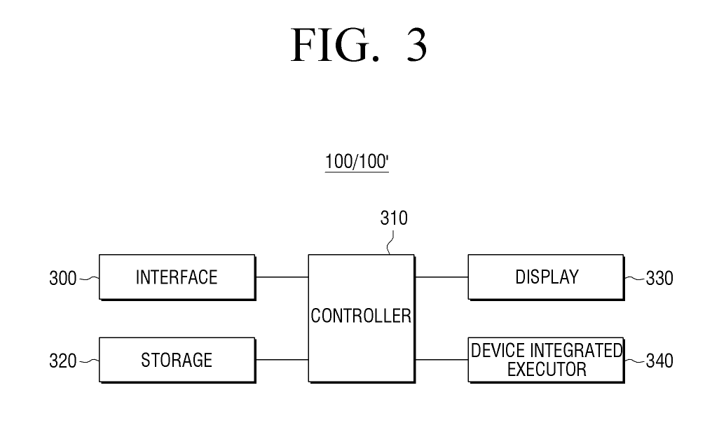

FIG. 3 is a block diagram illustrating another detailed structure of the image display apparatus illustrated in FIGS. 1A and 1B.

Referring to FIG. 3 and FIG. 1A, the image display apparatus 100 according to an embodiment of the present disclosure includes some or all of an interface 300, a controller 310, a storage 320, a display 330, and a device integrated executor 340

Compared to FIG. 2, the controller 310 and the device integrated executor 340 of FIG. 3 may perform operations identical or similar to the device integrated processor 210 of FIG. 2. For example, the controller 310 may include the CPU and the memory and the device integrated executor 340 may store the applications associated with the control screen of the user apparatus 110. Therefore, the device integrated executor 340 may provide the applications stored therein to the controller 310 or execute the applications within the device integrated executor 340 and provide the execution results.

The device integrated executor 340 may be implemented in the form of programs retrieved from nonvolatile memory as described above but all or some of the functions implemented in software form may be implemented in hardware form without any limit and therefore the embodiments of the present disclosure do not particularly limit any specific form.

The interface 300, the controller 310, the storage 320, the display 330, and the device integrated executor 340 of FIG. 3 have little differences from the interface 200, the device integrated processor 210, the display 220, and the storage 230 of FIG. 2.

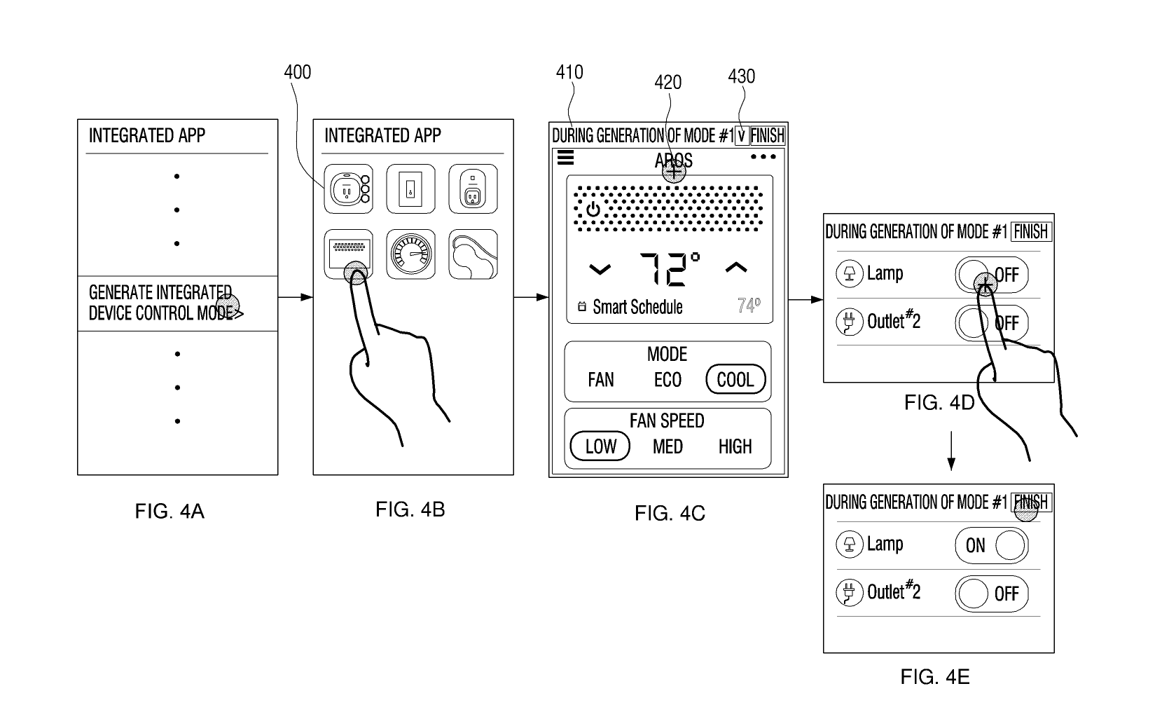

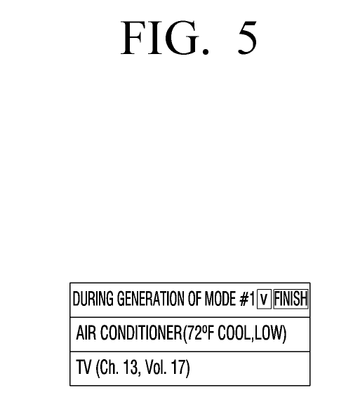

FIGS. 4A to 4E are diagrams illustrating the mode generation process according to an embodiment of the present disclosure and FIG. 5 is a diagram illustrating a screen which appears when a generation information confirmation item is selected from the screen of FIG. 4C.

Referring to FIGS. 4A to 4E along with FIG. 1A, the user of the image display apparatus 100 according an embodiment of the present disclosure may select the device integrated service item (or icon) displayed on the wallpaper (or home screen), as illustrated in FIG. 4A.

The image display apparatus 100 displays apparatus items 400 as illustrated in FIG. 4B on the screen when the user apparatus 110 of the user is designated in advance. When the user apparatus 110 is not designated, a separate process for designating the user apparatus 110 may be performed. Therefore, FIG. 4B is based on the premise that the user apparatus 110 has been previously designated.

When the user of the image display apparatus 100 selects the apparatus item 400 for the air conditioner in FIG. 4B, the control screen which may set the operation of the air conditioner may be illustrated as in FIG. 4C. The control screen may be preferably implemented in the form provided from the third party apparatus 140 of FIG. 1A.

The image display apparatus 100 may further display mode generation information 410 on whether the current user has generated any mode together with the control screen or as a portion of the control screen and a generation information confirmation item 430 which may confirm the generated information. The image display apparatus 100 may display a visual symbol 420 such as a ‘+’ bubble icon along with the control screen on the screen. The bubble icon indicates that a display state may be changed. The visual symbol 420 may be implemented in various forms such as a highlight display and a display button, in addition to a bubble icon.

As illustrated in FIG. 4C, the control screen includes various control items for setting the operation of an air conditioner. Various control items include a temperature control item for controlling temperature, a fan speed item for controlling fan speed, etc.

For the user to generate air conditioner mode Mode #1, the visual symbol 420 is positioned on the specific item of the control screen. In this case, to inform the user that the visual symbol 420 is in the selectable area of the specific item, the display state may be changed. The user may recognize that the corresponding item may be selected, and thus may touch and select the visual symbol 420. As a result, the control information on the corresponding control item is set in the Mode #1. The control information indicating that an object is the fan speed and the detailed value is “Low” may be stored. For example, each object and the detailed value indicating the control item may be stored in memory.

After the operation of setting the air conditioner is completed, the user may perform a process of setting the operation of a lamp or multiple user apparatus for device integrated control as illustrated in FIG. 4D. Although not illustrated in detail, after the user completes the operation of setting the air conditioner, the user may return to the screen of FIG. 4B to additionally perform a process of selecting the apparatus item 400 corresponding to the lamp or multiple user apparatus. Further, a separate process may also be performed so that the corresponding process is included in the same mode along with the air conditioner. For example, a separate screen for selecting the mode is additionally shown and thus the user's selection may be requested.

While the screen of FIG. 4D is displayed, the user switches the state of the displayed user apparatus as illustrated in FIG. 4E and then selects a generation completion button. The image display apparatus 100 may generate the mode and inform the user that the mode is generated. The image display apparatus 100 may display the mode generation screen on which the mode is generated or simply inform the user that the mode is generated in the form of a pop-up window. The process corresponds to displaying the integrated control screen according to an embodiment of the present disclosure.

When the user selects the generation information confirm item 430 from the screen of FIG. 4C, the user may confirm the control information of the user apparatus 110 in the mode which is currently illustrated in FIG. 5.

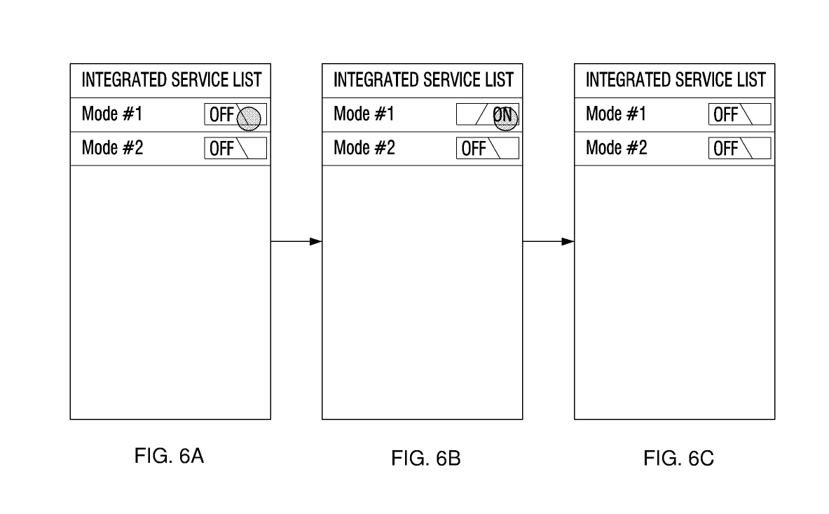

FIGS. 6A to 6C are diagrams illustrating a list of pre-generated modes.

Referring to FIGS. 6A to 6C along with FIGS. 1A and 5, although not separately illustrated in the drawings, a mode confirmation item which may confirm the pre-generated mode may be generated on the screen of FIG. 4B. Alternatively, when a menu button of the image display apparatus 100 is selected, the mode confirmation item may appear in the form of a pop-up window.

When the corresponding mode confirmation item is selected, the image display apparatus 100 may display the list of the pre-generated modes on the screen as illustrated in FIGS. 6A to 6C. The user may turn on or off any of the pre-generated specific modes. The change may be performed by a control item (or mode control item). As illustrated in FIG. 6B, the corresponding mode may be enabled by turning on the specific mode.

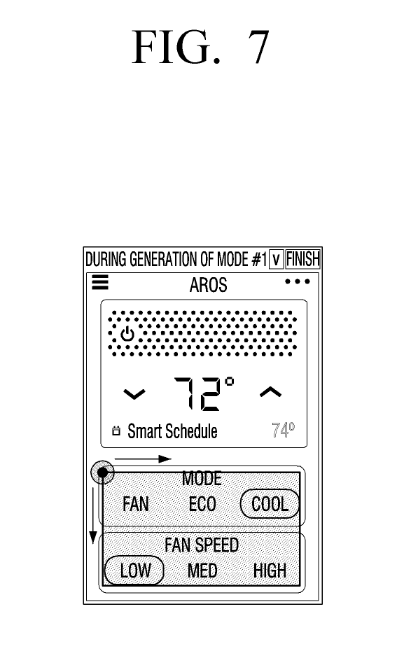

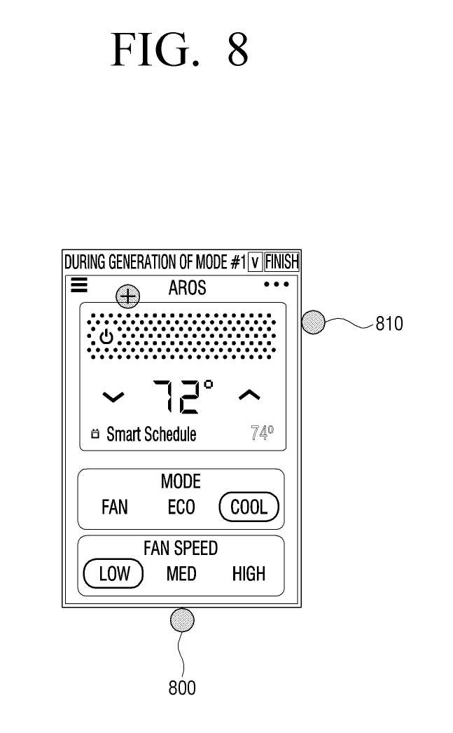

FIGS. 7 and 8 are diagrams for describing the process of selecting the control item from the control screen.

Referring to FIGS. 7 and 8 along with FIGS. 1A and 4, the image display apparatus 100 according to an embodiment of the present disclosure may display the control screen on the screen of the image display apparatus 100 as illustrated in FIG. 4B.

When the user of the image display apparatus 100 uses the visual symbol 420 to generate the plurality of control items as the control information in a group, the user may move the visual symbol 420 to a specific position as illustrated in FIG. 7, select the visual symbol 420, and then set an area by the drag operation. When the area is set, the image display apparatus 100 senses the dragged area to determine what item is included in the category.

When the user of the image display apparatus 100 generates the control information on all the control items displayed on the control screen, the user drags the overall area to designate the area as illustrated in FIG. 7, but as illustrated in FIG. 8, the user may also perform the setting by simply using the buttons formed in the image display apparatus 100.

When a home button 800 and a power supply button 810 are pressed while the image display apparatus 100 displays the control screen for generating the mode, the image display apparatus 100 selects all the control items. The detailed design thereof may be changed without any limit by a manufacturer of the image display apparatus 100, a program designer, etc., and therefore the embodiments of the present disclosure are not limited to the above description.

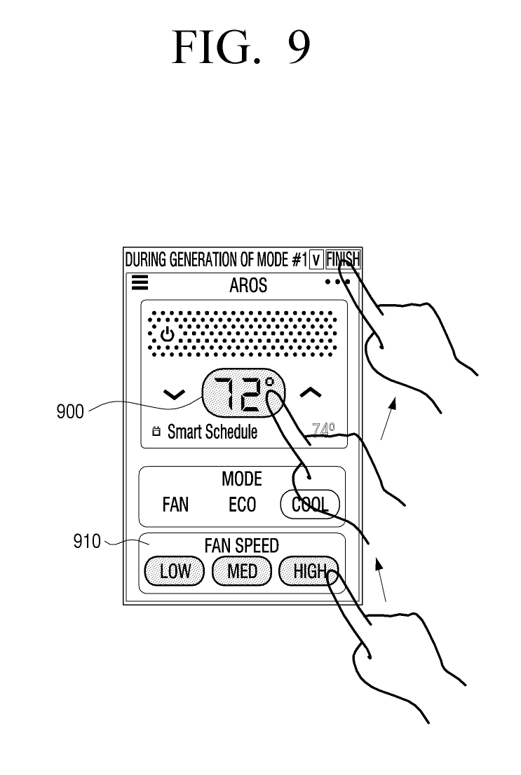

FIG. 9 is a diagram for describing the process of generating a control item on the control screen as the control information.

Referring to FIG. 9 along with FIG. 4, the image display apparatus 100 according to an embodiment of the present disclosure may display the setting value for a temperature control item 900 on the screen in advance of the state in which the control screen as illustrated in FIG. 4C is displayed and then generate the control information of the corresponding item in this state.

For example, to generate the plurality of control items as the control information in a group, the temperature control item 900 is displayed as 72° and the fan speed item 910 is selected using a finger's touch or the visual symbol 420 to select the high fan speed, thereby generating the state on the control item displayed on the screen as the control information. The image display apparatus 100 generates the setting value displayed as the temperature control item 900 and the information of the highlighted fan speed item 910 as the control information.

The memory within the image display apparatus 100 stores an adjustment value for the temperature control item 900 and when the adjustment value is adjusted by the user, updates the adjustment value stored therein. Since the image display apparatus 100 may know the adjustment value of the control item displayed on the current screen, the corresponding information may be set as the control information of the mode. Therefore, the adjustment value may not actually be highlighted. However, according to an embodiment of the present disclosure, the completion button may be selected in the state in which the setting value displayed as the temperature control item 900 is also highlighted and therefore the embodiment of the present disclosure is not limited.

When the image display apparatus 100 displays the control screen on the screen as illustrated in FIG. 9, it may inform the user of the selectable control item. To differentiate the selectable control item from the item which may not be selected, a color of a letter, a font, highlighting, etc., may be changed. For example, when an item which may not be selected is black, the selectable item may be displayed red or blue. The item which may not be selected may be highlighted at a concentration different from that when the control item is selectable. The display button, icon, and the like for informing the user of a selectable item may also be displayed on the control item or near the control item. The control item may be changed by various schemes of changing shapes of edge portions of the control item. The convenience to a user may be increased by informing the user that the corresponding item is a control item which may be selected. As described above, the embodiments of the present disclosure may implement various examples and are not limited.

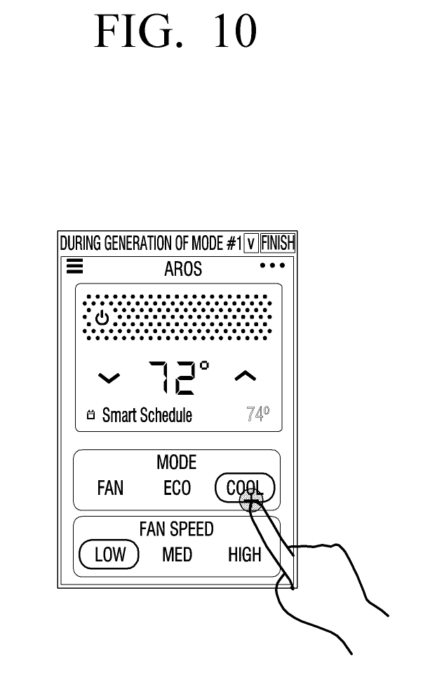

FIG. 10 is a diagram for describing maintenance of the setting value when a layout of the control screen is changed.

Referring to FIG. 10 along with FIGS. 1A and 4, when the user selects a control item on the control screen, the image display apparatus 100 according to the an embodiment of the present disclosure stores the coordinate values for the control item and then does not use the previously stored coordinate values.

Since the control screen may be changed without any limit depending on whether the user uses the control screen provided from a third party, the coordinate values for each control item are not stored but the information on the control item indicating that the mode is a ‘cool’ state may be stored. Therefore, even though the layout for the control screen is changed, the pre-stored control information may be continuously used.

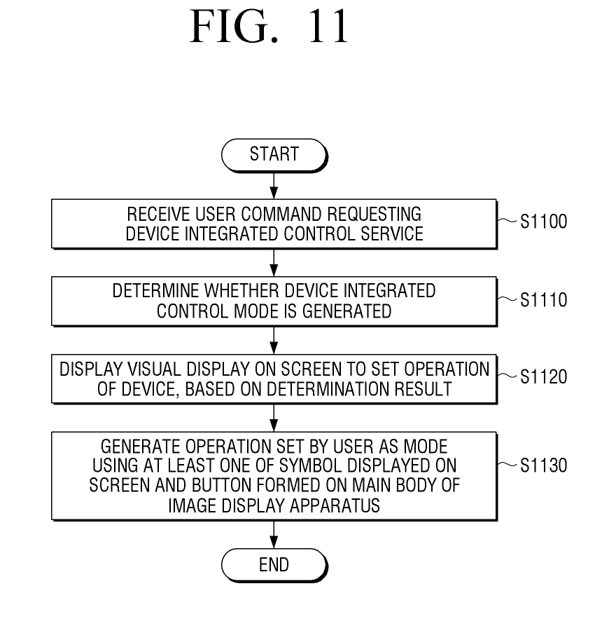

FIG. 11 is a flow chart illustrating a process of driving an image display apparatus according to an embodiment of the present disclosure.

Referring to FIG. 11 along with FIG. 1A, the image display apparatus 100 according to an embodiment of the present disclosure receives a user command requesting the device integrated control service from the user at step S1100. For example, the image display apparatus 100 may confirm the user command by allowing the user to select the icon displayed on the wallpaper.

In the next step, the image display apparatus 100 determines whether the device integrated control mode is generated at step S1110. When the user selects the apparatus item corresponding to the specific user apparatus 110 from the screen, it may be determined that the mode is generated. If the mode confirmation item is selected, the image display apparatus 100 does not determine the mode confirmation item as the mode generation process.

If it is determined that the mode is generated, the image display apparatus 100 further displays the visual symbol for setting the operation of the user apparatus 110 along with the control screen on the screen at step S1120.

In the next step, the user of the image display apparatus 100 positions the visual symbol in the specific control item of the control screen and then presses the visual symbol to set the control information on the corresponding control item in the mode or selects the buttons provided in the image display apparatus 100 to select the control item and set the selected control item as the mode at step S1130.

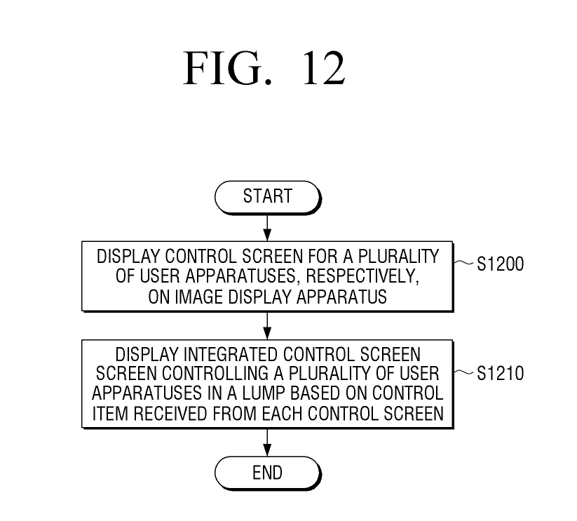

FIG. 12 is a flow chart illustrating an image display method according to an embodiment of the present disclosure.

Referring to FIG. 12 along with FIG. 1A, the image display apparatus 100 according to an embodiment of the present disclosure displays the control screen for at least one user apparatus at step S1200.

For the device integrated control, the apparatus item designated by the user may be displayed on the screen. The apparatus may be the user apparatus 110 of the user. If any apparatus item is selected, the control screen corresponding to the selected apparatus item is displayed. The control screen includes the control item associated with the operation control of the user apparatus 110. When a first apparatus item is selected, the image display apparatus 100 displays a first control screen and when a second apparatus item is selected, the image display apparatus 100 displays a second control screen having a different format from the second control screen. The first control screen and the second control screen may be implemented by applications provided by the service providing apparatus 130 of FIG. 1A. The shape of the layout of the output screen may change depending on whether the first control screen and the second control screen use an application.

If the control item on the control screen displayed on the screen is selected, the image display apparatus 100 displays the integrated control screen which controls a plurality of functions for at least one user apparatus in a group based on the selected control item at step S1210.

The image display apparatus 100 generates the selected control item (or control information on the control item) as the integrated control mode to display the integrated control screen. The image display apparatus 100 may use the visual symbol displayed on the screen to generate the mode, for example, the above-mentioned bubble icon and at least one of the buttons provided in the image display apparatus 100.

Although the case in which all the components configuring an embodiment of the present disclosure are combined with each other as one component or are combined and operated with each other as has been described, the present disclosure is not necessarily limited thereto. All the components may be operated optionally coupled with one or more components within the scope of the present disclosure. In addition, although each of the components may be implemented by one independent hardware form, some or all of the respective components which are selectively combined with each other may be implemented by a computer program having a program module performing some or all of the functions combined with each other in one or plural hardware. Code and code segments configuring the computer program may be inferred by those skilled in the art to which the present disclosure pertains. The computer program is stored in non-transitory computer readable media and is read and executed by a computer, thereby making it possible to implement an embodiment of the present disclosure.

The non-transitory computer readable medium is not a medium that stores data in a volatile memory device, such as a register, a cache, a RAM memory, and the like, but is a storage medium that semi-permanently stores data therein and is readable by a device. The programs described above may be stored and provided in the non-transitory computer readable medium such as a CD, a digital versatile disk (DVD), flash memory, a hard disk, a Blu-ray disk, a USB, a memory card, a ROM, and the like.

Although embodiments of the present disclosure have been illustrated and described, the present disclosure is not limited to the above-mentioned particular embodiments, but may be variously modified by those skilled in the art to which the present disclosure pertains without departing from the spirit and scope of the present disclosure as claimed in the claims. Such modifications should also be understood to fall within the scope of the present disclosure.

What is claimed is:

1. An image display method of an image display apparatus, comprising:
displaying a control screen for at least one user apparatus on the image display apparatus;
selecting a control item displayed on the control screen as a control command of the at least one user apparatus; and
displaying an integrated control screen for controlling a plurality of functions for the at least one user apparatus in a group based on the selected control item.

2. The image display method as claimed in claim 1, wherein displaying the control screen includes displaying a visual symbol used to select the control item on the control screen, and
wherein the control item is selected using at least one of the visual symbol and a button formed on a main body of the image display apparatus.

3. The image display method as claimed in claim 2, wherein the visual symbol includes one of an icon movable by a drag operation, a display button, and a highlight display, and when the visual symbol is positioned in a selectable area of the control item by the movement, a display state of the visual symbol is changed.

4. The image display method as claimed in claim 2, further comprising:
positioning the visual symbol which is displayed on the control screen, on the control item,
wherein in displaying the integrated control screen, when the visual symbol positioned by the positioning of the visual symbol is selected, the integrated control screen is generated based on the selected control item.

5. The image display method as claimed in claim 2, further comprising:
designating an area including a plurality of control items by dragging the visual symbol on the control screen,
wherein in displaying the integrated control screen, the integrated control screen is generated based on the plurality of control items included in the area.

6. The image display method as claimed in claim 2, wherein in displaying the integrated control screen, the integrated control screen is generated based on all the control items on the control screen being selected by using the button formed on the main body.

7. The image display method as claimed in claim 1, wherein displaying the integrated control screen includes displaying items to be controlled in a group by turning on and off the at least one user apparatus.

8. The image display method as claimed in claim 1, wherein the control screen for the at least one user apparatus is displayed on a screen by executing different applications.

9. The image display method as claimed in claim 1, wherein in displaying the control screen, a generation information confirmation item for confirming the selected control item is displayed on the control screen.

10. An image display apparatus, comprising:
a display that displays a control screen for at least one user apparatus on the image display apparatus; and
if a control item displayed on the control screen is selected as a control command of the at least one user apparatus, a controller that controls an integrated control screen for controlling a plurality of functions for the at least one user apparatus in a group based on the selected control item to be displayed on the display.

11. The image display apparatus as claimed in claim 10, wherein the display further displays a visual symbol being used to select the control item on the control screen, and
wherein the control item is selected using at least one of the visual symbol and a button formed on a main body of the image display apparatus.

12. The image display apparatus as claimed in claim 11, wherein the visual symbol includes one of an icon movable by a drag operation, a display button, and a highlight display, and when the visual symbol is positioned in a selectable area of the control item by the movement, a display state of the visual symbol is changed.

13. The image display apparatus as claimed in claim 11, wherein the controller controls the display to position the visual symbol, which is displayed on the control screen, on the control item, and if the positioned visual symbol is selected, generates the integrated control screen based on the selected control item.

14. The image display apparatus as claimed in claim 11, wherein the display further displays an area including a plurality of control items selected by dragging the visual symbol on the control screen, and
wherein the controller generates the integrated control screen based on the plurality of control items included in the area.

15. The image display apparatus as claimed in claim 11, wherein the controller generates the integrated control screen based on all the control items on the control screen being selected by using the button formed on the main body.

16. The image display apparatus as claimed in claim 10, wherein the display further displays items to be controlled in a group by turning on and off the at least one user apparatus.

17. The image display apparatus as claimed in claim 10, wherein the control screen for the at least one user apparatus is displayed on a screen by executing different applications.

18. The image display apparatus as claimed in claim 10, wherein the control screen includes a generation information confirmation item for confirming the selected control item, and
if the generation information confirmation item is selected, the display displays the selected control item.

19. A non-transitory computer readable recording medium having recorded thereon a program for executing an image display method of an image display apparatus, wherein the image display method includes:
displaying a control screen for at least one user apparatus on the image display apparatus;
selecting a control item on the control screen as a control command of the at least one user apparatus; and
displaying an integrated control screen for controlling a plurality of functions for the at least one user apparatus in a group based on the selected control item.

20. The non-transitory computer readable recording medium as claimed in claim 19, wherein displaying the control screen includes displaying a visual symbol used to select the control item on the control screen, and
wherein the visual symbol includes one of an icon movable by a drag operation, a display button, and a highlight display, and when the visual symbol is positioned in a selectable area of the control item by the movement, a display state of the visual symbol is changed.
